(19) United States
(12) Patent Application Publication
(10) Pub. No.: US 2005/0027566 A1
(43) Pub. Date: Feb. 3, 2005

(54) Terminology management system

(76) Inventor: Robert Emmons Haskell, Chester Springs, PA (US)

Correspondence Address: Alexander J. Burke;Intellectual Property Department, 5th Floor, 170 Wood Avenue South, Iselin, NJ, 08830, US

(21) Appl. No.: 10/886,397

(22) Filed: Jul. 7, 2004

Related U.S. Application Data
(60) Provisional application No. 60/485,877, filed on Jul. 9, 2003.

(51) Int. Cl. G06F 17/60

(52) U.S. Cl. 705/2

(57) ABSTRACT

Various embodiments provide a system for use in managing healthcare terminology supporting operation of a healthcare enterprise, comprising: a first repository including a first set of healthcare related terms; a second repository including a centralized second set of healthcare related terms encompassing terms of a plurality of terminology sets including the first set of healthcare related terms, the centralized second set including a group of one or more component terms associated with an individual term of the first set; and an interpretation processor for selecting, from the centralized second set, a subgroup of the group of one or more component terms associated with an individual received term of the first set in response to processing of context information associated with the individual received term, using predetermined rules.

### CROSS-REFERENCES TO RELATED APPLICATIONS

This application claims priority to pending U.S. Provisional Patent Application Ser. No. 60/485,877 (Attorney Docket No. 2003P09929 US01), filed 9 Jul. 2003.

### BACKGROUND

Terminologies are the language of healthcare, providing the means to express and structure data describing healthcare delivery (e.g., medical conditions, services, results, observations, outcomes). They are an essential ingredient of healthcare information systems, which provide the technical infrastructure to enable their capture, storage, and use. They are also the means to express best practice knowledge for efficient and efficacious healthcare delivery. Unfortunately, today's healthcare terminologies, IT systems, and knowledge sources are diverse, fragmented, and disconnected from one another. Each terminology and system, either implicitly or explicitly, has an underlying model or structure that defines the rules for its construction. Each is unique to its own purpose, and is an entity unto itself. Each discrete terminology (e.g., ICD, LOINC, ICNP, NANDA, etc.) has a structure; each reference terminology set (SNOMED CT, ISO Nursing Action, etc.) has a structure; each interface standard has a structure (e.g., HL7 RIM), each discrete information and messaging system has an information and message structure, and each information system has a data structure. In the terminology domain meta-structures are maintained, such as the Meta Thesaurus of the National Library of Medicine and evolving reference terminologies like SNOMED CT, but there is no general definition of how these are connected into healthcare information systems and the messages that define how data are to be shared between them. Current systems do not take a holistic view of the terminology, information system, and knowledge domains. Terminologies are fragmented, redundant, inconsistent, and incomplete. Information systems and the messages that connect them are fragmented, redundant, inconsistent, and incomplete. Terminologies are inserted into systems and data structures and messages without regard for how the data are ultimately be integrated to support integrated healthcare delivery. They become the center for expressing healthcare knowledge.

### SUMMARY

The inventor has recognized that from a systems view, the terminology IT infrastructure is the integration point for linking diverse terminologies together, for linking the terms within the terminologies together into information structures that express clinical and financial knowledge, and for linking the specific terms within these structures to the supportive information and knowledge that helps define them. These structures integrate and interoperate to facilitate the mapping of the vocabulary clinicians use to describe and codify healthcare into structured and consistent terms to store in the underlying data structures of an information system and into reference information used to facilitate decision making.

Thus, various embodiments provide a system for use in managing healthcare terminology supporting operation of a healthcare enterprise, comprising: a first repository including a first set of healthcare related terms; a second repository including a centralized second set of healthcare related terms encompassing terms of a plurality of terminology sets including the first set of healthcare related terms, the centralized second set including a group of one or more component terms associated with an individual term of the first set; an interpretation processor for selecting, from the centralized second set, a subgroup of the group of one or more component terms associated with an individual received term of the first set in response to processing of context information associated with the individual received term, using predetermined rules.

### BRIEF DESCRIPTION OF THE DRAWINGS

A wide variety of potential embodiments will be more readily understood through the following detailed description of certain exemplary embodiments, with reference to the accompanying drawings in which:

FIG. 1 is a block diagram of an exemplary embodiment of a system 1000;

FIG. 2 is a block diagram of an exemplary embodiment of a system 2000;

FIG. 3 is a block diagram of an exemplary embodiment of a system 3000;

FIG. 4 is a block diagram of an exemplary embodiment of an information device 4000;

FIG. 5 is a flowchart of an exemplary embodiment of a method 5000; and

FIG. 6 is a flowchart of an exemplary embodiment of a method 6000.

### DEFINITIONS

When the following terms are used herein, the accompanying definitions apply:
can—is capable of, in at least some embodiments.
centralized—concentrated on or clustered around a central point and/or purpose.
code—at least one character representing and/or corresponding to data having a predefined value or values. For example, a code can represent and/or correspond to a particular problem, history, sign/symptom, observation, pattern, test result, structure, marker, condition, disorder, disease, diagnosis, test, procedure, treatment, outcome, intervention, study, orderable service, medication, drug, activity, entity, organization, facility, equipment, resource, role, relationship, workflow, patient, provider, insurer, insurance plan, insurance plan characteristic, market, country, demographic characteristic, financial characteristic, and/or administrative characteristic, etc. A set of codes may conform to and/or be compatible with, for example, ICD (International Classification of Diseases) codes, 9th Edition, Clinical Modification, (ICD-9-CM), Volumes 1, 2 and 3; ICD-10, which is maintained and distributed by the U.S. Health and Human Services department; HCPCS (Healthcare Financing Administration Common Procedure Coding System); NDC (National Drug Codes); CPT4 (Current Procedural Terminology); Fourth Edition CDPN (Code on Dental Procedures and Nomenclature); SNOMED-RT “Systematicized Nomenclature of Medicine, Reference Terminology” by the College of American Pathologists; UMLS (Unified Medical Language System), by the National Library of Medicine; LOINC Logical Observation Identifiers, Names, and Codes; Regenstrief Institute and the Logical Observation Identifiers Names and Codes (LOIN®) Committee; Clinical Terms also known as “Read Codes”; DIN Drug Identification Numbers; Reimbursement Classifications including DRGs (Diagnosis Related Groups); CDT Current Dental Terminology; NIC (Nursing intervention codes); and Commercial Vocabulary Services (such as HealthLanguage by HealthLanguage Inc.); etc.
concept—a rendering comprising a specific human-understandable meaning and not rendered merely as a code.
concept-oriented terminology—terminology in which the concepts are formally represented in a manner that makes them suitable for computer processing.
context information—information regarding the part of a text or statement that surrounds and/or is related to a particular word and/or passage and determines and/or suggests the meaning of that particular word and/or passage.
controlled health terminology—set of terms intended for clinical use.
diagnosis code—a code comprising one or more characters associated with a particular patient diagnosis, medical condition, or treatment.
disease code—at least one character corresponding to a known and/or theorized disease.
document—a physical and/or electronic collection of related data elements. If physical, a document comprises one or more sheets of paper and the related data elements printed thereon. A document can be and/or can represent a record of a patient encounter with a healthcare organization.
enterprise—an entity and/or organization.
firmware—machine-readable instructions that are stored in a read-only memory (ROM). ROM's can comprise PROMs and EPROMs.
genetic—of or relating to genetics or genes. Examples of genetic information include information regarding DNA, RNA, complementary DNA or RNA, transfer RNA (tRNA), messenger RNA (mRNA), and Expressed Sequence Tags (EST), etc.
identifier—a group of symbols that are unique to a particular entity, object, activity, service, relationship, characteristic, and/or document. An identifier can be, for example, a medical record number. An identifier can be human and/or machine readable and/or understandable, such as for example, a number, alphanumeric string, code, bar code, RFID, etc.
information model—identifies and describes core concepts and structures of information that exist in records and can be exchanged between systems. It specifies data and its semantics, major state transitions, and/or vocabulary for domains.
machine-readable medium—a physical structure from which a machine can obtain data and/or information. Examples include memory devices, punch cards, etc.
memory device—any device capable of storing analog or digital information.
network interface—any device, system, or subsystem capable of coupling an information device to a network. For example, a network interface can be a telephone, cellular phone, cellular modem, telephone data modem, fax modem, wireless transceiver, Ethernet card, cable modem, digital subscriber line interface, bridge, hub, router, or other similar device.

'omics—any of genomics, structural genomics, functional genomics, proteomics, metabonomics, metabolomics, bioinformatics, molecular medicine, etc.
processor—a device for processing machine-readable instruction. A processor can be a central processing unit, a local processor, a remote processor, parallel processors, and/or distributed processors, etc. The processor can be a general-purpose microprocessor, such the Pentium III series of microprocessors manufactured by the Intel Corporation of Santa Clara, Calif. In another embodiment, the processor can be an Application Specific Integrated Circuit (ASIC) or a Field Programmable Gate Array (FPGA) that has been designed to implement in its hardware and/or firmware at least a part of an embodiment disclosed herein.
reference information model (RIM)—depicts different types of healthcare information and relationships among them.
reference model—depicts the components of a system and their interrelationships. Generally intended to represent fundamental structures that transcend specific function, technology, operations, or organizations.
reference terminology—a set of canonical concepts, their structure, relationships and, if present, their systematic and formal definitions. Can define fundamental, atomic, context-independent terms used to describe healthcare, and their relationship to one another. Typically vendor neutral, technology neutral, patient neutral, product neutral, and process neutral. Its general reference terms can be “pre-coordinated” into data entry terms (e.g., problems) for quick selection and entry, and/or “post-coordinated” into administrative terms (e.g., ICD-9-CM diagnoses) for financial and/or administrative management purposes.
reference terminology model (RTM)—The reference terminology model represents a generic synthesis of individual terminology models. Therefore, it defines an interlingua. By definition, each terminology can be mapped to the reference terminology, and consequently to any other terminology that is also mapped to the same reference terminology model. Terminology models are synthesized to create the reference terminology model. The reference terminology model does not by itself define/create terminology models, but does link to them for mapping purposes. It is used to, in various embodiments:
   support the intentional definition of domain-related concepts;
   facilitate the representation of domain-related concepts and their relationships in a manner suitable for computer processing;
   provide a framework for the generation of compositional expressions from atomic concepts within it;
   facilitate the mapping among domain-related concepts from various terminologies, including those developed as interface terminologies and statistical classifications;
   enable the systemic evaluation of terminologies and associated terminology models for purposes of harmonization; and
   provide a language to describe the structure of domain-related concepts to enable appropriate integration with information models (e.g., HL7 RIM).
render—to make perceptible to a human.
repository—an individual database or multiple distributed databases.
resources—means available to an organization for fulfilling, maintaining, and/or increasing production and/or profit, including plant, labor, and/or raw materials; assets. Examples can include healthcare personnel, physical facilities, equipment, supplies, vendors, and/or contractors, etc.
term—a word, phrase, code, and/or identifier corresponding to one or more concepts.
terminology—a set of terms representing a system of concepts within a specified domain; a controlled vocabulary; a collection of specific names of instances of items in an information or terminology model. The following are examples of various terminologies:
   interface terminology (“what the user sees”);
   administrative terminology (“code sets”); and
   reference terminology (“a map of the territory”).
terminology model—an explicit representation of a system of concepts that: is utilized and/or optimized for terminology management; supports the intentional definition of concepts; supports the extensional mapping among terminologies; and/or depicts the associative relationship between an aggregate (molecular) expression and more primitive (atomic) concepts. The terminology model describes the richer content, structure and semantics behind each term within the terminology. It defines the general rules for how the terms within the terminology are constructed, and how they are related to one another. Terminologies represent the content of the terminology models. Where no explicit and formal terminology model exists, it can be created from the terminology, but in general the terminology is spawned from the terminology model, either implicitly or explicitly.
transaction message—a definition and/or specification of how data are to be shared between information systems.
user interface—any device for rendering information to a user and/or requesting information from the user. A user interface includes at least one of textual, graphical, audio, video, animation, and/or haptic elements.

### DETAILED DESCRIPTION

Various embodiments provide a system for use in managing healthcare terminology supporting operation of a healthcare enterprise, comprising: a first repository including a first set of healthcare related terms; a second repository including a centralized second set of healthcare related terms encompassing terms of a plurality of terminology sets including the first set of healthcare related terms, the centralized second set including a group of one or more component terms associated with an individual term of the first set; an interpretation processor for selecting, from the centralized second set, a subgroup of the group of one or more component terms associated with an individual received term of the first set in response to processing of context information associated with the individual received term, using predetermined rules. Various embodiments also comprise a plurality of tertiary repositories containing definitions for the resources, workflows, and referent image and “omic” data needed to support and enable healthcare delivery, as described through the terminologies in the first and second repositories; a linkage processor for connecting the detail resources and workflow definitions to associated terms in the first and second repositories.

Certain implementations, according to system principles, provide the infrastructure for generically connecting terminology and information domains, and to execute these relationships and associated mappings within and across domains. A connection between any terminology and any data model or message is established by tracing connections based on specific terms and their relationships and linkages. These linkages are defined and executed within a terminology server, in addition to the definitions of the terminology and information models themselves. A specific terminology, and its associated model, can be registered and/or integrated into a reference terminology, and its underlying reference terminology model. The reference terminology model provides the means to map one terminology into another and to identify the underlying concepts that define the terminology. The terms within the both the terminologies and reference terminology link to information content defined within the information system. Clinical decision-making is then driven by selecting information content based on the terms appropriate to the point of care activities. The terminology server is at the heart of the IT system, linking to its distributed information and knowledge content and organizing the terms and terminologies used to describe health care delivery.

Certain implementations of the central terminology server according to system principles provide the following features:

A single point of registration and management of a terminology and special purpose micro glossaries created from it.

A single point of registration and integration of a terminology into a reference terminology. By integrating a terminology into a reference terminology, connectivity with other terminologies and with the information domain is standardized. The reference terminology provides a standard means of structuring and documenting healthcare delivery.

A systemic view of information and knowledge, and the terminologies that identify its content. A cross reference is established that allows queries for details about a specific terminology used in a message or information system, or details about how and where a specific terminology or micro glossary is used in messages or information models. Mappings between terminologies and data attributes in information/data models are identified and enabled.

A structure for defining and managing relationships across terminologies, and between terminologies and information models, and between terms within the terminologies and reference information/knowledge further defining the terms. For example, for information system master files, specifying the allowed relationships between health professionals, the organizations and locations in which they are allowed to deliver care, the services they are allowed to order, the health plans and payers that cover the services dispensed. For another example, identifying the image and genetic features that help define a disease.

Certain systems provide a single point of maintenance for registering a terminology into the complete terminology and information domain. Once defined, its relationship to other domain-relevant terminologies, information models, data models, messages, and reference knowledge is established. A generic meta structure provides a systemic means to embrace and facilitate the assimilation of the diversity that currently exists, into a complete, consistent, and cohesive whole.

Particular systems provide a mapping infrastructure that defines and maintains the integration and interoperability linkages across terminology, information, and knowledge domains. The term provides the basis for this linkage.

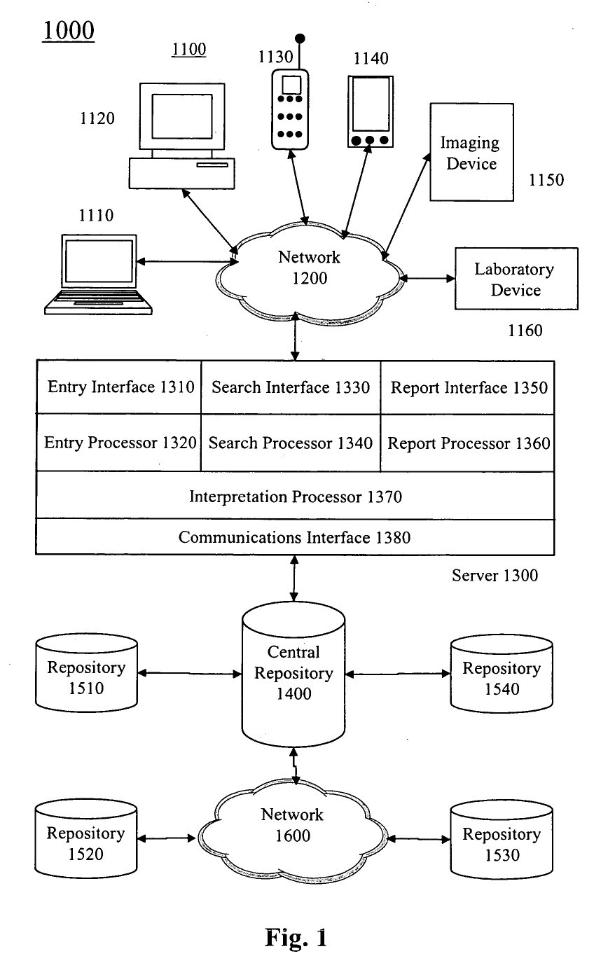

FIG. 1 is a block diagram of an exemplary embodiment of a system 1000, which comprises any number of information devices 1100, such as laptop computer 1110, desktop computer 1120, cellphone-enabled computer 1130, personal digital assistant 1140, imaging device 1150, laboratory device 1160, etc. Any of information devices 1100 are coupled to a network 1200, such as the Internet. Any of information devices 1100 may function as a client in a client-server relationship. Any information device may run a browser for rendering information obtained from the network. The browser may display the information in a native format, such as HTML, and/or can utilize a scripting language, plug-in, and/or helper application, such as Java, ActiveX, VisualBasic, QuickTime, Flash, Acrobat, etc.

Any number of servers 1300 are coupled to network 1200. Any of servers 1300, may function as a terminology server, web server, data server, mail server, and/or file server, etc. Server 1300 comprises a data entry interface 1310 and a data entry processor 1320. Server 1300 comprises a search interface 1330 and a search processor 1340. Server 1300 comprises a report interface 1350 and a report processor 1360. Server 1300 comprises an interpretation processor 1370 and a communications interface 1380.

At least one central repository 1400 is coupled to server 1300. Central repository 1400 functions as a terms and relationships repository. Coupled to central repository 1400, either directly or via a network 1600, are a plurality of repositories 1510, 1520, 1530, 1540, etc., that can comprise the associated definition and knowledge to support each individual term in the central repository 1400.

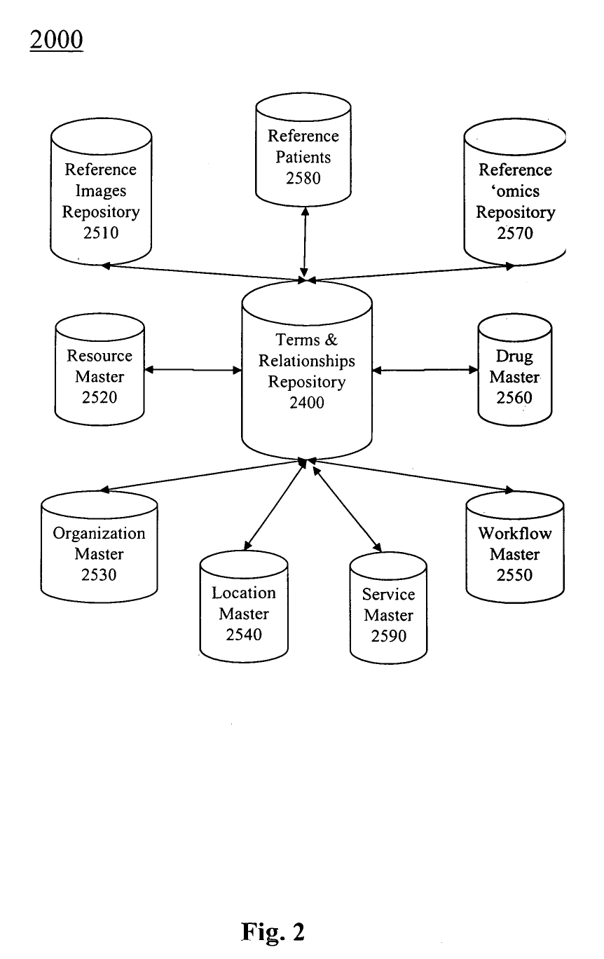

FIG. 2 is a block diagram of an exemplary embodiment of a system 2000, which comprises centralized terms and relationships repository 2400. System 2000 comprises a plurality of repositories (also called “masters”) directly and/or indirectly coupled to a term or set of terms in centralized terms and relationships repository 2400. For example, reference images repository 2510 comprises one or more databases comprising graphical information, such as photographs, diagrams, charts, illustrations, videos, etc. For example, reference images repository 2510 may comprise a “best practices” radiograph of a lung cancer. As another example, reference images repository 2510 may comprise a “best practices” EKG strip of an ideal human heart. As yet another example, reference images repository 2510 may comprise a plurality of EKG strips for various manifestations of an acute myocardial infarction and/or gross (macroscopic) photographs of various manifestations of severe coronary atherosclerosis.

Resource master 2520 comprises one or more databases comprising resource information, such as information relating to people, equipment, locations, contracts, availability constraints, etc. needed to support a specific tasks or set of tasks.

Organization master 2530 comprises one or more databases comprising organization information, such as information relating to organizational structures, functions, relationships, etc. An “Organization” is a logical business entity comprised of people, resources, and facilities performing various functions.

Location master 2540 comprises one or more databases comprising physical and/or virtual location information, such as information relating to countries, regions, states, counties, cities, blocks, campuses, buildings, floors, rooms, beds, coordinates (e.g., GPS, GIS, etc.), etc. A “location” identifies a physical place to which patients are directed and/or assigned, or a place where services are provided and/or scheduled.

Service master 2590 comprises one or more databases comprising at least one service definition, which has the meaning and characteristics of a service in the form of a complete set of possible attributes (e.g., identifiers, description, options, rules, linkages to other services, prices, costs, etc.). A service is an intentional action of interest that has happened, can happen, is happening, is intended to happen, or is requested/demanded to happen to, for, or by a patient, potentially on a specific date and time.

Workflow master 2550 comprises one or more databases comprising workflow definitions, such as information relating to tasks, task sequences, rules for altering task sequences, necessary resources to complete a task, task prerequisites, etc.

Drug master 2560 comprises one or more databases comprising drug information, such as information relating to brand and generic drug names, prescribing categories, description, clinical pharmacology, indications, usage, recommended dosages, administration, side effects, adverse reactions, contraindications, over-dosage, warnings, precautions, manufacturer, source, available forms, and/or references, etc.

Reference 'omics repository 2570 comprises one or more databases comprising 'omics information, such as information relating to genomics, structural genomics, functional genomics, proteomics, metabonomics, metabolomics, bioinformatics, molecular medicine, etc. For example, reference'omics repository 2570 may comprise any portion of the model human DNA determined by the Human Genomics Project. As another example, reference'omics repository 2570 may comprise various manifestations of one or more genetic markers correlated with a predisposition to autism.

Reference patient repository 2580 comprises one or more databases comprising the clinical and/or financial records of exemplar patients relevant to a term or set of terms. For example, teaching cases related to specific diseases or medical problems would be associated with the terms identifying these diseases or medical problems.

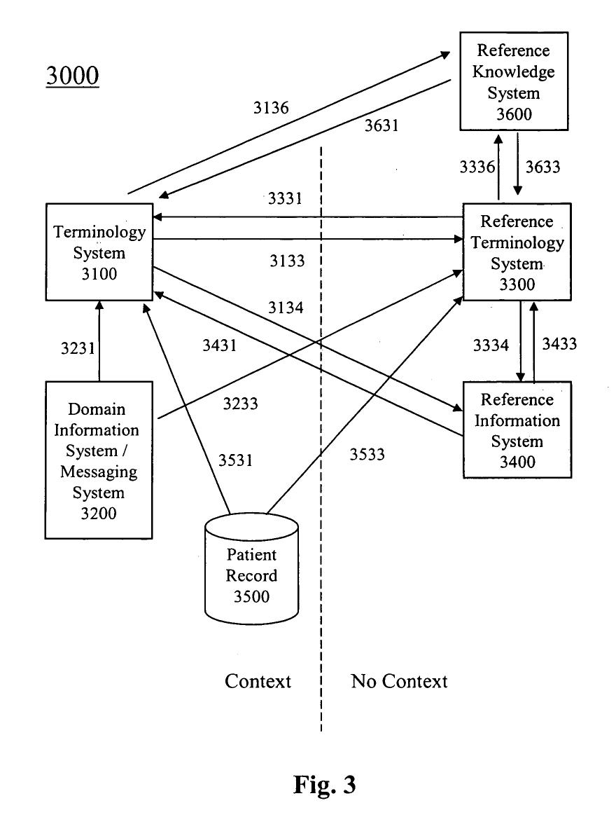

FIG. 3 is a block diagram of an exemplary embodiment of a system 3000, which comprises a plurality of related (sub)systems, such as terminology system 3100, domain information system and/or messaging system 3200, reference terminology system 3300, reference information system 3400, patient record 3500, and/or reference knowledge system 3600.

Various relationships may exist between the components of system 3000. These relationships describe the linkages needed for sharing information between the components. For example, via relationship 3133, terminology system 3100 supplies candidate vocabularies, composition/decomposition rules, candidate terms and/or an exact/partial match indicator to reference terminology system 3300. To link the terminology system to a reference terminology system, the reference terminology identifier, reference terminology class, and reference term(s) are stored in the terminology system. If multiple reference terminology systems exist, the previous information is repeated for each one. Via relationship 3331, reference terminology system 3300 supplies candidate vocabularies, composition/decomposition rules, candidate terms and/or an exact/partial match indicator to terminology system 3100. In order to link a reference terminology system to a plurality of terminology systems, a terminology identifier, terminology class, and the terminology term(s) are stored in the reference terminology system for each appropriate terminology system.

Via relationship 3134, terminology system 3100 supplies a terminology class to reference information system 3400. Via relationship 3431, reference information system 3400 supplies a vocabulary identifier to terminology system 3100.

Via relationship 3334, reference terminology system 3300 supplies a terminology class to reference information system 3400. The reference information system identifier (e.g., HL7 RIM), reference information system Class (e.g., Act), and reference information system Attribute are stored within the Class (e.g., Act Code). This defines the basic rules for expressing a terminology in an information system. Via relationship 3433, reference information system 3400 supplies a vocabulary identifier to reference terminology system 3300. The reference terminology identifier (e.g., SNOMED-CT), reference terminology Class (e.g., Concept), and reference terminology Attribute (e.g., ConceptID) are stored. This defines the rules for expressing a terminology in an information system within the domain of the reference information system. The relationship between reference terminology and reference information models is one of context and structure. The generic meta-class in the reference terminology model can be mapped to a corresponding meta-class in the reference information model, to identify where the terminology concepts defined in the reference terminology model are to be included into the reference information model.

Via relationship 3231, domain information system and/or messaging system 3200 supplies a vocabulary identifier to terminology system 3100. Via relationship 3233, domain information system and/or messaging system 3200 supplies a vocabulary identifier to reference terminology system 3300. Information about a term is contained in its terminology and underlying terminology model, and is usually not re-expressed in the information model. The information model contains the term itself, but nothing about its structure or about its relationships to other terms. Information about how the term is derived is contained in the terminology models; information about how the term is used is contained the information/message model. The content and context of the terminology domain is not brought into the other.

Via relationship 3531, patient record 3500 supplies vocabulary identifier and associated term to terminology system 3100. Via relationship 3533, patient record 3500 supplies a vocabulary identifier and associated term(s) to reference terminology system 3300.

Via relationship 3136, terminology system 3100 supplies knowledge component identifier and associated term to knowledge system 3600. Via relationship 3631, knowledge system 3600 supplies vocabulary identifier and associated term to terminology system 3100.

Via relationship 3336, reference terminology system 3300 supplies knowledge component identifier and term to knowledge system 3600. Via relationship 3633, knowledge system supplies vocabulary identifier and term to reference terminology system 3300.

Certain relationships are not necessarily appropriate. For example:

Reference information system does not link directly to a terminology system. It remains context independent. However, a specific terminology identifier can be registered into a Class and Attribute within the reference information model.

Reference information system does not link to an information system/model or messaging system/model. It remains context independent.

Reference terminology system does not link to an information system/model or messaging system/model. It remains context independent.

Terminology system does not link to an information system/model or messaging system/model. It remains context independent.

Information system/model or messaging system/model only implicitly links to the reference information system. By definition it is constructed using the Aliases and Attributes of the reference information system, but with values specific to the domain being described.

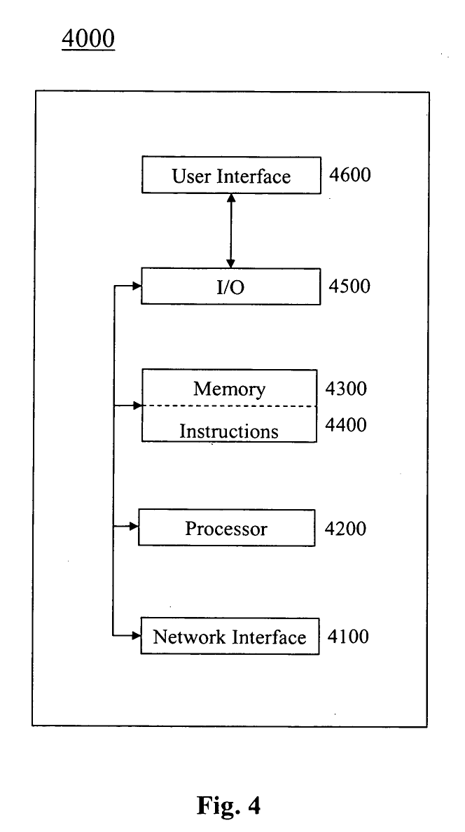

FIG. 4 is a block diagram of an exemplary embodiment of an information device 4000, which in certain operative embodiments comprises, for example, information devices 1100, and/or server 1300 of FIG. 1. Information device 4000 comprises any of numerous well-known components, such as for example, one or more network interfaces 4100, one or more processors 4200, one or more memories 4300 containing instructions 4400, one or more input/output (I/O) devices 4500, and/or one or more user interfaces 4600 coupled to I/O device 4500, etc.

In certain exemplary embodiments, via one or more user interfaces 4600, such as a graphical user interface, a user may view a rendering of information related to entering data into, viewing, maintaining, querying, and/or obtaining a report from one or more repositories.

For example, when querying for patient outcomes, any of the following categories of terms can be used: process outcomes, structure outcomes, system outcomes, outcomes assessment, health outcomes, patient outcomes, decision theory, decision analysis, effectiveness, quality monitoring, data monitoring, clinical trials data monitoring, audits, risk-taking, risk reduction, consequences, absolute risk, relative risk, benchmarks, endpoints, events, terminal events, reactions, effects, injury, morbidity, mortality, rates, errors, complications, success, treatment outcome, and/or treatment failure, etc.

Repositories can include databases of diseases, treatments, etiologies, clinical findings, therapies, procedures, and/or outcomes. Queries can target concepts at multiple levels of granularity, including, for example: finding; disease; procedure and intervention; observable entity; body structure; organism; substance;
pharmaceutical/biological product; specimen; physical object; physical force;
events; environments and geographical locations; social context; context-dependent categories; staging and scales; attribute; and/or qualifier value.

By way of further example, input, queries, and/or reports can be directed to any of the following groups and/or sets of terms:

Clinical Finding
Finding (e.g., swelling of calf)
Disease (e.g., tuberculosis)
Problem (e.g., diabetes)
Sign/symptom (e.g., shortness of breadth)
Procedure/intervention (e.g., biopsy of thyroid)
Observable entity (e.g., tumor stage)
Body structure (e.g., structure of liver)
Organism (e.g., bacterium)
Substance (e.g., blood plasma)
Pharmaceutical/biologic product (e.g., penicillin)
Specimen (e.g., blood specimen)
Physical object (e.g., catheter)
Physical force (e.g., abrasion)
Events (e.g., high winds)
Environments/geographical locations (e.g., emergency room)
Social context (e.g., organ donor)
Context-dependent categories (e.g., no dizziness)
Staging and scales (e.g., Apgar scale)
Attribute (e.g., controlled flow)
Qualifier value (e.g., unilateral)
Special Concept (e.g., active concept)

Disorder and Finding (Clinical Observation)
Finding Site
Causative Agent
Associated Morphology
Severity
Onset
Course
Episodicity
Interprets
Has Interpretation
Pathological Process
Associated Etiologic Finding
Temporally Follows
Has Definitional Manifestation
Occurrence
Stage
Subject of Information

Procedure
Procedure Site
Method
Direct Morphology
Direct Substance
Direct Device
Indirect Morphology
Indirect Device
Using
Access
Approach
Priority
Has Focus
Has Intent
Recipient Category
Access Instrument
Revision Status
Has Specimen
Component

Measurement Procedure
Has Measurement Component
Measurement Method
Has specimen
Time Aspect
Property
Scale Type

Specimen
Specimen Procedure
Specimen Source Topography
Specimen Source Morphology
Specimen Substance
Specimen Source Identity

Body Structure
Laterality
Part of

Additional Attributes
Has Active Ingredient
Associated Finding
Is indicated by
Is contraindicated by
Is a potential complication of
Is a potential cause of

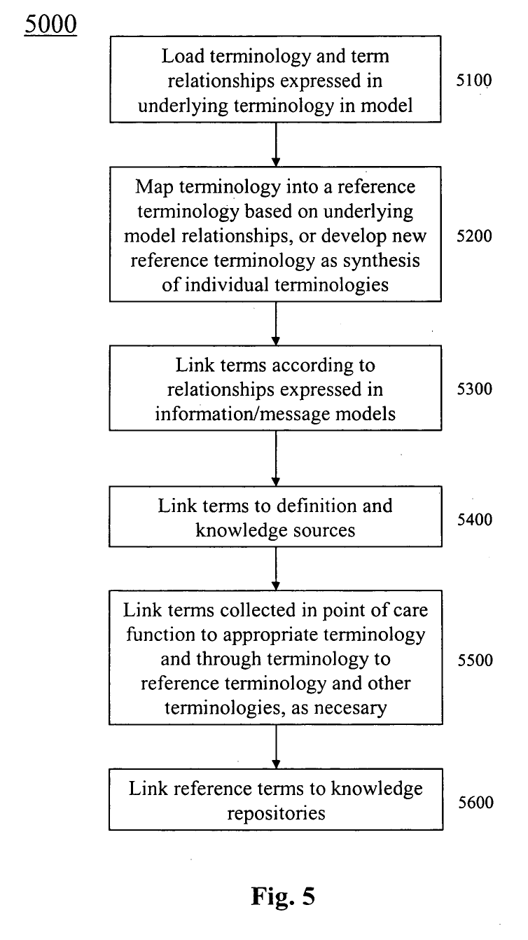

FIG. 5 is a flowchart of an exemplary embodiment of a method 5000. At activity 5100, the terms within a terminology are loaded into a terminology server. Appropriate relationships between terms in the terminology, as expressed in by the underlying terminology model, are also defined.

With regard to the terminology server and/or system, the following concepts and/or relationships frequently apply:
The terminology and reference terminology systems contain a complete definition of the terminology (e.g., system identifier, terms, term descriptions, term relationships, term synonyms, external equivalent terms, etc.).
The terminology system contains rules for how to decompose pre-coordinated terms into reference vocabulary terms, and how to compose terms that might represent pre-coordinated terms within the reference terminology.
Decomposition and composition rules identify sections of the reference terminology where more detailed relevant terms are found. These rules are frequently used to facilitate the mapping process. For example, pre-coordinated LOINC terms are comprised of a Component, Property Observation, Timing, System/Sample, Scale, and Method. The areas of the reference vocabulary that contains terms for each of these dimensions are identified.
Reference terminology system contains rules for each subscribing terminology for how to compose the terms within those terminologies.
Each term in the terminology system identifies candidate terms in the reference terminology that might be necessary to further define a pre-coordinated term, and that might require additional data entry in the point of care system for collecting information necessary to derive these more detailed terms.
Relevant candidate terms in a terminology and/or reference terminology system are identified for each term in the terminology vocabulary system. For example, pre-coordinated LOINC terms are comprised of a Component, Property Observation, Timing, System/Sample, Scale, and Method. The specific terms in the reference vocabulary that might define this term are identified to enable assembly of data entry forms, templates, text analysis, or whatever form of automated data collection and coding might occur.
Candidate terms are used to drive term encoding/collection at the point of care, to be sure necessary data are collected. Typically the candidate an indicator or exact or partial match, or is fully resolved when term is processed in IT system.
Candidate terms are used to drive term encoding/collection at the point of care, to be sure necessary data are collected. Typically the candidate term contains an indicator or exact or partial match, or is fully resolved when term mapping occurs through the reference vocabulary.
Each term in the reference terminology identifies the equivalent target term(s) in each of the subscribing terminology systems.
Each term in the terminology and reference terminology can link to reference knowledge repositories, which are master files used in other parts of the IT system to fully define processing the rules for the knowledge component (organizations, locations, services, workflows, reference images, reference genetics, reference cases).

At activity 5200, each term in a terminology is linked to one or more terms on the reference terminology model (and conversely the terms in the reference terminology are linked to the terminology), or a new reference terminology model and terminology is developed as a synthesis of individual terminology models.

At activity 5300, the terms or general classes of terms in the terminology (and reference terminology if not already done so) are linked according to the uses of the terms in particular information domains (e.g., order sets, physiological relationships, action sequences, causal relationships). For example, the standard ISO Nursing Actions model defines class relationships, and consequently term relationships for expressing nursing action sin an information or messaging system.

At activity 5400, the terms are linked to the reference sources that define them. For example, medical conditions (e.g., diagnoses, problems) are linked to reference data that help diagnose a patient by providing reference images, reference biomarkers, and reference cases.

At activity 5500, the data loaded in activities 5100 through 5400 are referenced by, for example, point of care IT function, by a term collected by an end user. The system and/or user searches for and finds the term in its terminology scheme, links the term to the reference terminology, and potentially maps the term to other terminologies, if necessary. The user enters the term or plurality of terms (explicitly or implicitly) into the system through any style of user interface (menu selection, voice to text, dictation through natural language processing, etc.) and term(s) is posted into a database attribute of an application database. Both term(s) and appropriate reference term(s) are stored in the database, which is described by a data model. For linking to the terminology, the terminology identifier, and the term itself, are stored. For linking to the reference terminology model, the reference terminology identifier, and the reference term(s)/concept(s) itself, are stored. The term is implicitly linked to its own terminology system, where context about the term is maintained. In various embodiments, the term is linked to:
equivalent terms in the reference terminology system, where context of the reference terms is maintained, and where mappings to other terminologies are maintained.
other related terms in the larger terminology to define the information context in which the term exists (e.g., if an observation, what was the associated order). For example, if a nursing action term, what other terms are necessary to completely describe the action, such as the performer, the target, and the route and dose if a medication.
appropriate knowledge sources further defining the term.

At activity 5600, the located reference terms (or the terms themselves) are linked to reference information in the associated knowledge repositories, which is subsequently displayed to the system end user to, for example, facilitate clinical decision making and/or to initiate a workflow sequence, if appropriate.

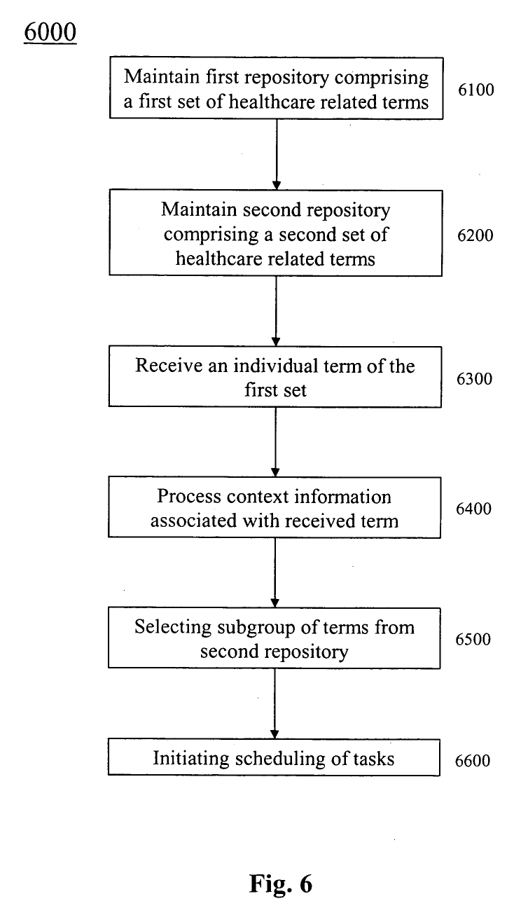

FIG. 6 is a flowchart of an exemplary embodiment of a method 6000. At activity 6100, a first repository is maintained, the first repository comprising a first set of healthcare related terms. At activity 6200, a second repository is maintained, the second repository comprising a centralized second set of healthcare related terms that comprise terms of a plurality of terminology sets, those terminology sets comprising the first set of terms. The centralized second set of healthcare related terms comprises a group of one or more component terms that are associated with an individual term from the first set of terms. At activity 6300, an individual term of the first set is received. At activity 6400, context information associated with the received term is processed. At activity 6500, in response to processing of the context information, a subgroup of terms of the group of one or more component terms are selected from the centralized second set of healthcare related terms using predetermined rules. At activity 6600, the scheduling of tasks is initiated based on the terms selected in activity 6500, the tasks to be performed by at least one healthcare worker to provide healthcare to a patient in response to the context information and terms of the subgroup.

Still other embodiments will become readily apparent to those skilled in this art from reading the above-recited detailed description and drawings of certain exemplary embodiments.

1. A system for use in managing healthcare terminology supporting operation of a healthcare enterprise, comprising:
a first repository including a first set of healthcare related terms;
a second repository including a centralized second set of healthcare related terms encompassing terms of a plurality of terminology sets including said first set of healthcare related terms, said centralized second set including a group of one or more component terms associated with an individual term of said first set; and
an interpretation processor for selecting, from said centralized second set, a subgroup of said group of one or more component terms associated with an individual received term of said first set in response to processing of context information associated with said individual received term, using predetermined rules.

2. A system according to claim 1, wherein:
said context information comprises patient treatment related information associated with a document from which said received term is derived.

3. A system according to claim 2, wherein:
said patient treatment related information comprises an identification of said document as being related to at least one of, (a) an order for administration of a medication to a patient, (b) a patient related laboratory test, (c) a patient examination and diagnosis, (d) a clinical test result report, and (e) a patient medical record.

4. A system according to claim 2, wherein:
a term of said subgroup identifies at least one task to be performed, and resources needed to perform said at least one task.

5. A system according to claim 4, wherein:
said resources include at least two of, (a) a healthcare worker, (b) a location, (b) a healthcare provider organization, (c) a medical service to be provided to a patient.

6. A system according to claim 1, wherein:
said interpretation processor selects a term from said first set of said first repository in response to data representing a received subgroup of said group of one or more component terms.

7. A system according to claim 1, wherein:
said first and second repositories are at least one of, (a) a single repository and (b) a plurality of repositories.

8. A system according to claim 1, wherein:
a term of said subgroup identifies a medical image.

9. A system according to claim 8, wherein:
said medical image is at least one of, (a) of a particular patient, and (b) a reference image used for identifying classic characteristics of a medical condition.

10. A system according to claim 1, wherein:
said received term comprises a plurality of received terms and said interpretation processor selects, from said centralized second set, at least one subgroup of a plurality of groups of one or more component terms associated with said plurality of received terms of said first set.

11. A system according to claim 1, wherein:
said document is a transaction message; and
said patient treatment related information is incorporated in said transaction message.

12. A system according to claim 1, wherein:
said context information comprises identification of a particular task being performed in a patient treatment related task sequence, said particular task being identified in a document from which said received term is derived.

13. A system according to claim 1, wherein:
said interpretation processor selects said subgroup of component terms using predetermined rules linking terms within said subgroup as being clinically relevant to at least two of, (a) a medication, (b) a laboratory test, (c) a diagnosis, and (d) a medical condition.

14. A system according to claim 1, wherein:
said subgroup of said group of one or more component terms comprises at least one term.

15. A system according to claim 1, wherein:
a term includes at least one of, a code and an identifier, used in healthcare delivery to a patient.

16. A system according to claim 15, wherein:
said code identifies at least one of, (A) a medical diagnosis code, (B) a medical procedure code, (C) a problem, (E) a sign/symptom, (F) an orderable service, (G) a medication, (H) a procedure, (I) an outcome, (J) an intervention, and (K) an observation.

17. A system according to claim 15, wherein:
said code identifies a workflow process comprising a sequence of healthcare worker performed tasks.

18. A system according to claim 15, wherein:
said identifier is used for identifying at least one of, (i) a medical condition, (ii) a healthcare financial item, (iii) a healthcare billing item, (iv) a physician specialty, (v) a treatment, (vi) a medicine and (vii) a healthcare related service.

19. A system according to claim 15, wherein said identifier is used for identifying a patient.

20. A system according to claim 1, wherein:
a term is used for identifying at least one of (a) a health provider organization, (b) a location in an organization, (c) a healthcare worker, (d) a payer organization, (e) a particular health plan, and (f) patient related information.

21. A system according to claim 1, wherein:
a term of said subgroup indicates genetic information.

22. A system according to claim 1, wherein:
said genetic information identifies at least one of, (a) a particular medical condition, (b) a particular disease or ailment, and (c) a person.

23. A system according to claim 21, wherein said genetic information comprises at least one of, (a) DNA information, (b) RNA information, (c) complementary DNA or RNA information, (d) transfer RNA (tRNA) information (e) messenger RNA (mRNA) information, and (f) Expressed Sequence Tags (EST).

24. A system according to claim 21, wherein:
said genetic information comprises a gene array expression.

25. A system according to claim 21, wherein:
said genetic information comprises a genetic marker.

26. A method for use in managing healthcare terminology supporting operation of a healthcare enterprise, comprising the activities of:
maintaining a first repository including a first set of healthcare related terms;
maintaining a second repository including a centralized second set of healthcare related terms encompassing terms of a plurality of terminology sets including said first set of healthcare related terms, said centralized second set including a group of one or more component terms associated with an individual term of said first set; and
selecting, from said centralized second set, a subgroup of said group of one or more component terms associated with an individual received term of said first set in response to processing of context information associated with said received term, using predetermined rules.

27. A system for initiating a sequence of tasks supporting delivering healthcare to a patient and to be performed by at least one healthcare worker, comprising:
a first repository including a first set of healthcare related terms;
a second repository including a centralized second set of healthcare related terms encompassing terms of a plurality of terminology sets including said first set of healthcare related terms, said centralized second set including a group of one or more component terms associated with an individual term of said first set and particular terms of said subgroup being associated with particular tasks to be performed by at least one healthcare worker and particular context information; and
an interpretation processor for:
selecting, from said centralized second set, a subgroup of said group of one or more component terms associated with an individual received term of said first set in response to processing of context information associated with said received term; and
initiating scheduling of particular tasks to be performed by at least one healthcare worker to provide healthcare to a patient in response to said context information and terms of said subgroup.
